(19) United States
(12) Patent Application Publication
(10) Pub. No.: US 2021/0064870 A1
(43) Pub. Date: Mar. 4, 2021

(54) MONITORING SYSTEM FOR CONTROLLING WIRELESSLY CONTROLLED PLANTER

(71) Applicant: JANG AUTOMATION CO., LTD., Cheongju-si (KR)

(72) Inventor: Jae Su JANG, Cheongju-si (KR)

(73) Assignee: JANG AUTOMATION CO., LTD., Cheongju-si (KR)

(21) Appl. No.: 16/578,813

(22) Filed: Sep. 23, 2019

(30) Foreign Application Priority Data
Aug. 30, 2019 (KR) 10-2019-0107377

(51) Int. Cl. G06K 9/00; G06T 19/00; G05D 1/08; A01B 79/02; A01B 79/00

(52) U.S. Cl. CPC G06K 9/00657; G06K 9/00671; G06T 19/006; G06T 2207/30188; A01B 79/02; A01B 79/005; G05D 1/0891

(57) ABSTRACT

Disclosed is a monitoring system for controlling a wirelessly controlled planter (M), which is connected to a wireless controller (C) that is configured with at least a plurality of buttons and joysticks for remote control. The monitoring system includes: a detecting module (S10) including a camera (S11) and a GPS (S12); a communication module (S20); a calculating module (S30); a safety module (S40); and a display module (S50). Accordingly, images and positions to secure a visual field for controlling and detected information of the planter are output to the controller, so that an operator safely controls the planter at any place without watching the planter in a planting field and can maintain the planter easily.

### CROSS REFERENCE TO RELATED APPLICATION

The present application claims priority to Korean Patent Application No. 10-2019-0107377, filed Aug. 30, 2019, the entire contents of which is incorporated herein for all purposes by this reference.

### BACKGROUND OF THE INVENTION

### Field of the Invention

The present invention generally relates to a monitoring system for controlling a wirelessly controlled planter which is remotely controlled in connection with a wireless controller configured with at least a plurality of buttons and joysticks. More particularly, the present invention relates to a monitoring system for controlling a wirelessly controlled planter, wherein images and positions to secure a visual field for controlling and detected information of the planter are output to the controller, so that an operator can safely control the planter at any place without watching the planter in a planting field and can maintain the planter easily, visible and audible alarms for poor planting are generated and a variety of information and total amount of planting amount and amount of applied fertilizer are remotely transmitted to the controller for outputting, so that it is possible to maximize completion of overall planting work.

### Description of the Related Art

Generally, planting seeds to grow grain or vegetables is called ‘planting’. Conventional planting has been done as a person plants seeds directly on farmland. However, recently, due to development of agricultural technology, a planter that automatically performs planting work has been developed and spread. Therefore, the planting is done by using the planter in most regions except a special region where operation of the planter is difficult.

At this point, the planter may be classified into an attachable type planter attached to agricultural machinery such as a cultivator, a tractor, and a multi-purpose cultivator operated by on operator, and into a self-propelled type planter directly operated by the operator. The attachable type planter is used when planting work is performed on a large and flat terrain where operation of agricultural machinery is easy. The self-propelled type planter is used when planting work is performed on a small and uneven terrain where operation of agricultural machinery is difficult.

Meanwhile, in recent years, as rural areas have an aging farming population due to the avoidance of farming of young adults and middle-aged people, most drivers of agricultural machinery are elderly people.

That is, when the planting work is performed using the attachable type planter, there is a problem that accidents frequently occur due to low driving skill and inadvertent operation during the driving of agricultural machinery by the elderly people.

Specifically, when a cultivator or a multi-purpose cultivator is driven, no small labor is needed thereto with driving skill. However, elderly people have difficulty driving agricultural machinery due to lack of muscle strength for easy operation of the cultivator or the multi-purpose cultivator.

On the other hand, when the planting work is performed using a self-propelled type planter, elderly people should perform the planting work while driving the planter for a long time in the middle of the day when there is a lot of sunshine, so that exhaustion of physical strength is caused considerably.

It is also possible to hire an outside worker to solve the difficulty of planting due to exhaustion of physical strength, but considering the difficult economic situation, the above method is difficult to apply because a separate labor cost is required.

### DOCUMENTS OF RELATED ART

(Patent Document 1) Korean Utility Model Registration No. 20-0410295 (Title: Seed machine for bulbil and assembly having seed machine)

### SUMMARY OF THE INVENTION

Accordingly, the present invention has been made keeping in mind the above problems occurring in the related art, and the present invention is intended to propose a monitoring system for controlling a wirelessly controlled planter, in which a planting unit is provided in an RC bogie which is remotely controlled by wireless control, so that remote-control performance of planting work is possible, images and positions to secure a visual field for controlling and detected information of the planter are output to a controller, so that an operator can safely control the planter at any place without watching the planter in a planting field and can maintain the planter easily, and visible and audible alarms for poor planting are generated and a variety of information and total amount of planting amount and amount of applied fertilizer are remotely transmitted to a display for outputting, so that it is possible to maximize completeness and convenience of overall planting work.

In order to achieve the above objectives, according to one aspect of the present invention, there is provided a monitoring system for controlling a wirelessly controlled planter, which is remotely controlled in conjunction with a wireless controller that is configured with at least a plurality of buttons and joysticks, the monitoring system includes: a detecting module including a camera and a GPS, at least one camera being attached to the planter to shoot a surrounding and a planting area and the GPS measuring a location of the planter and a moving distance thereof in real time; a communication module provided in each of the controller and the planter, sending and receiving a detected signal of the detecting module and a travelling signal of the planter; a calculating module coding the detected signal sent to the controller into readable sensing information and decoding manipulating information of an operator into the travelling signal that is perceived by the planter; a safety module analyzing travelling state by comparing the sensing information to reference information set by the operator, and outputting warning sound and a warning light depending on the travelling state; and a display module attached to the controller and outputting an observation item showing a surrounding of the planter on the basis of the sensing information and a measurement item showing an operational state of the planter.

At this point, the detecting module may further include: an ultrasonic sensor provided in a front portion and a rear portion of the planter to sense an obstacle; at least one incline sensor provided in the planter to sense rolling, yawing, and pitching; and an OBD terminal connected to an electronic control unit (ECU) of the planter to detect a battery state and amount of fuel.

In addition, the communication module of the controller according to the present invention may be connected to a server of Rural Development Administration via a private network to receive crop growth information such as a size of ridge, a head interval, a germination temperature, a cultivation temperature, a seasonal planting and harvesting time, a number of seeds, an interval of rows, and an interval of plants, depending on an operator's request.

In addition, the calculating module according to the present invention may perform compositing of front and rear images of the planter which are taken by the camera, overlay a front and rear composite image with a real picture or an object modeled in three dimensions of the planter, and reflect sensing information of the incline sensor on the overlaid planter so as to code a real travelling state into an augmented or virtual reality.

In addition, depending on an operator's choice, the calculating module according to the present invention may code the composite image into an aerial view and a bird's-eye view, the aerial view being taken from a vertically top-down point of view and showing the planter in line with a travelling direction thereof, and a bird-eye view being a view taken from a bird's point of view and showing the planter in line with the travelling direction thereof and geographic features.

In addition, the safety module according to the present invention may perform analysis of an image of a planting area of the camera to determine seed dropping and seed planting and record position information of the GPS with a picture for an area of poor planting.

In addition, the observation item of the display module according to the present invention may be organized: on a left side in the display module, into a front field showing a front image of the planter; and a rear field showing a rear image of the planter at a lower end of the front field, and the measurement item thereof may be organized: on a right side of the display module, into a connection field indicating a frequency sensitivity state; a voltage field indicating a battery power state of the planter; a fuel field indicating fuel amount or operable time of the planter; a posture field indicating an angle of the planter; a direction field indicating a travelling direction and speed of the planter; and a moving field indicating a moving distance and an area of the planter, in a set pattern.

As described in the above configuration and operation, the present invention provides effects as follows.

First, a planting unit is provided in an RC bogie which is remotely controlled by wireless control so that remote-control performance of planting work is possible. Accordingly, it is possible to improve completion and convenience of the planting work, to reduce workforce, and to perform precise planting in conjunction with a travelling speed of the RC bogie.

Secondly, images and positions to secure a sight for controlling of the planter are output to the controller, so that the operator can control the planter at any place without consistently watching the planter in a planting field. Accordingly, the operator can control the planter without regard to the operator's health.

Third, information required for controlling and planting is shown so that anyone can understand the information and the system is realized so that the planting work is automatically set. Accordingly, anyone can control easily and conveniently the planter regardless of proficiency, and self-travelling of the planter is possible depending on the setting so that automatic planting work is possible.

Fourth, visible and audible alarms for poor planting are generated, and thus a variety of information and total amount of planting amount and amount of applied fertilizer are remotely transmitted to a display for outputting. Accordingly, production management can be easy due to planting history and completeness of overall planting work can be maximized.

Fifth, the monitoring system collects and displays crop growth information from a server of Rural Development Administration for anyone to know. Accordingly, growth environment can be created on the basis of the collected information so that overall crop management can be improved.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view showing an overall monitoring system according to the present invention;

FIG. 2 is a block diagram showing the overall monitoring system according to the present invention;

FIGS. 3 to 6B are reference views showing implementation states of the monitoring system according to the present invention;

FIGS. 7 to 9 are views showing a configuration of a planter of the monitoring system according to the present invention from different angles;

FIGS. 10 to 14 are sectional views showing a configuration of a planting module that is a main part of the planter; and

FIG. 15 is a plane view showing deformation of an RC bogie that is a main part of the planter of the present invention.

### DETAILED DESCRIPTION OF THE INVENTION

Hereinbelow, configuration, operation, and effects of the present invention will be described at one time with reference to the accompanying drawings.

It should be noted that the terms and words used in the specification and the claims should not be construed as being limited to ordinary meanings or dictionary definitions. Meanwhile, the embodiment described in the specification and the configuration illustrated in the drawings are merely examples and do not exhaustively present the technical spirit of the present invention. Accordingly, it should be appreciated that there may be various equivalents and modifications that can replace the embodiments and the configurations at the time at which the present application is filed.

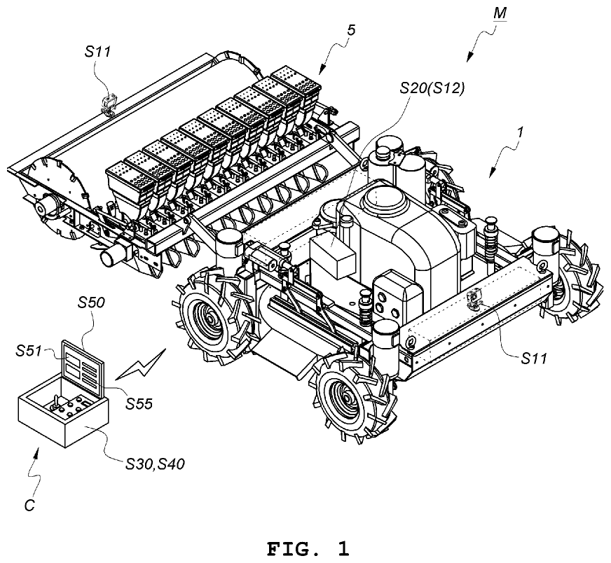

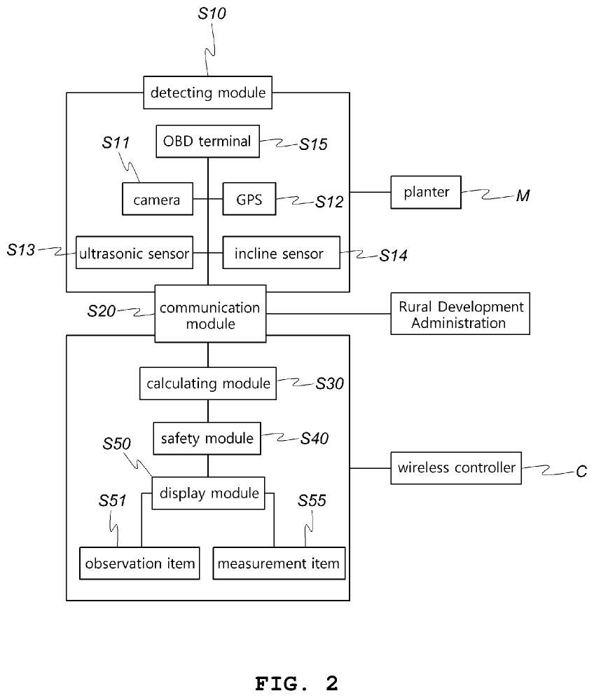

The present invention relates to a monitoring system for controlling a wirelessly controlled planter M which is remotely operable in connection with a wireless controller C configured with at least a plurality of buttons and joysticks. As shown in FIGS. 1 and 2, the monitoring system for controlling the wirelessly controlled planter includes: a detecting module S10; a communication module S20; a calculating module S30; a safety module S40; and a display module S50 as main components.

The monitoring system of the present invention is configured such that a planting unit is installed in an RC bogie that is remotely operable by wireless control to enable remote-control performance of a planting work and images and positions to secure a visual field required for travelling of the planter are output to the controller. Thus, the monitoring system of the present invention is realized so that an operator can operate the planter at any place without having to watch the planter at a plant field so as to greatly improve convenience and efficiency of plating work.

The detecting module S10 measures information of the planter M which is needed for remote travelling and is configured with a camera S11 and a GPS S12, as shown in FIGS. 1 and 2. At least one camera S11 is attached to the planter M to capture images of surroundings and planting areas and the GPS S12 measures positions and moving distances of the planter M by being attached thereto.

That is, at least one camera S11 is attached to each of a front end of the RC bogie 1 and a rear end of the planting unit 5, which constitute the planter M, to capture front and rear images. It is also preferable that, for safe and precise travelling, at least one camera is attached to opposite sides of the RC bogie 1 or the planting unit 5 to capture front and rear images. In addition, the GPS S12 is attached to the planter M together with the communication module S20, which will be described below, to measure current position and moving distance by triangulation using satellite signals.

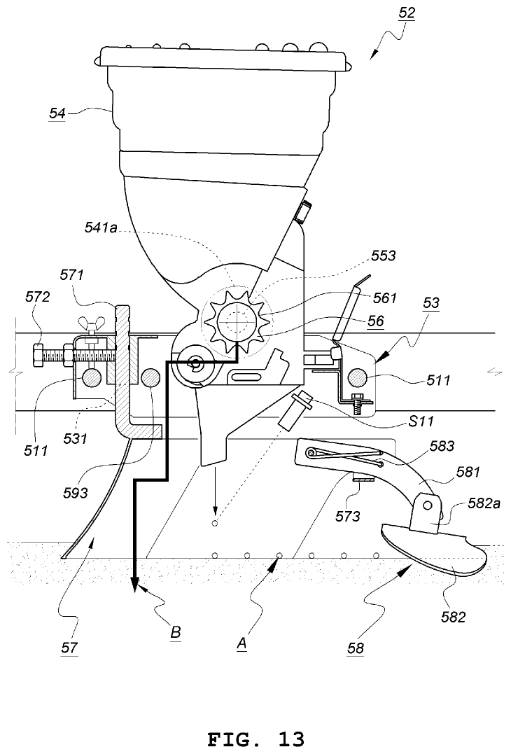

At this point, the camera S11 captures images of a planting area by being attached to one side of a mounting unit 53 of the planting unit 5 to captures images of a planting area, as shown in FIG. 13. That is, the camera S11 captures images of a seed dropped by a planting roller 55, which will be described below, with a falling position in a planting groove provided in a ridge so as to induce the operator to check with the naked eye or to check automatically through image analysis so that planting is performed precisely.

At this point, the detecting module S10 is preferably configured with an ultrasonic sensor S13, an incline sensor S14, and an on board diagnostics (OBD) terminal S15. The ultrasonic sensor S13 is attached to the front and rear of the planter M like the camera S11 to measure obstacles. The incline sensor S14 is attached to the planter M together with the communication module S20 like the GPS S12 to measure postures such as rolling, yawing, and pitching.

The OBD terminal S15 is connected with an OBD 16-pin diagnostic connector of an electronic control unit (ECU) of the planter M to measure a battery state and amount of fuel. When the planter M does not have an electronic control unit, it is also possible that the planter M has separately a battery sensor and a fuel level sensor which measure the battery state and amount of fuel, respectively.

As shown in FIGS. 1 and 2, the communication module S20 is mounted on each of the controller C and the planter M to send and receive a detecting signal of the detecting module S10 and a travelling signal of the planter M. The communication module S20 may be one or a combination of telecommunication modems, which is connected to a communication modem or a private communication network on the basis of Bluetooth, ZigBee, Wi-Fi, and the like.

At this point, the communication module S20 of the controller C collects growth information by connecting to a ‘Nongsaro’ server of the Rural Development Administration of Korea via a private network. That is, the growth information disclosed in the Rural Development Administration of Korea is collected and output to the display module S50 to be described below in accordance with a setting sequence.

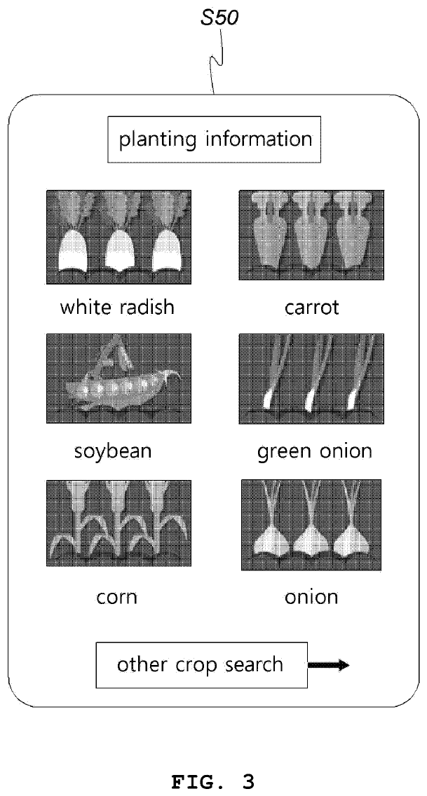

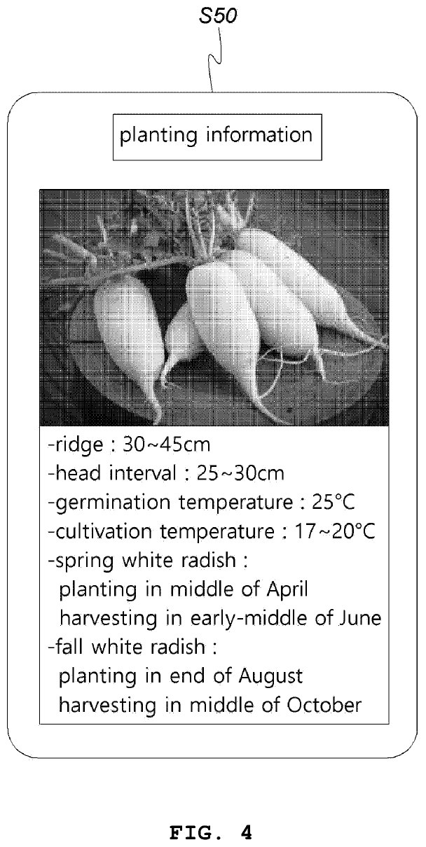

For example, depending on the operator, it is possible that planting information of each crop such as white radish, carrot, soybean, green onion, corn, onion, etc. are output as selectable images, as shown in FIG. 3. When the operator selects white radish, as shown in FIG. 4, the display module S50 outputs the growth information of white radish such as a size of ridge, a head interval, a germination temperature, a cultivation temperature, a seasonal planting and harvesting time, the number of seeds, an interval of rows, and an interval of plants and so on.

In addition, it is possible that the display module S50 is configured to output a calendar displaying a crop cultivation schedule, and to notify with a text or alarm in conjunction with an operator's portable terminal.

As shown in FIGS. 1 and 2, the calculating module S30 codes the detecting signal sent to the controller C into readable sensing information, and decodes manipulating information of the operator into the travelling signal that is perceived by the planter M. The calculating module S30 may be mounted to the controller C or the planter M, and may be both the controller C and the planter M like the communication module S20.

That is, the calculating module S30 codes a mechanical signal which is output from the detecting module S10 and input by the communication module S20 into a letter, a digit, and a picture code which are comprehensible for the operator. Whereas, the calculating module S30 decodes the travelling information which is manipulated by the operator into a digital or analog signal, which is cognizable for actuators constituting the planter M, to output to the detecting module S10 or the communication module S20.

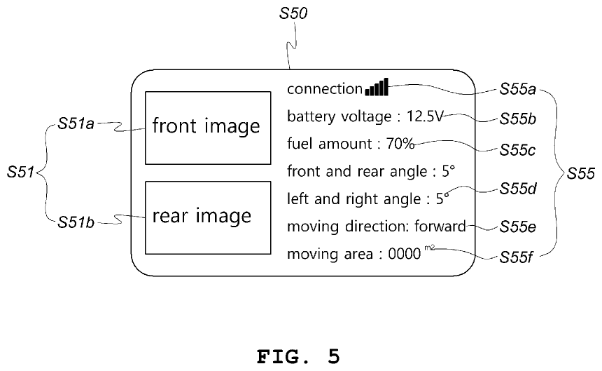

The calculating module S30 processes software realizing the safety module S40 and the display module S50 in real time. That is, the display module S50, which will be described later, outputs front and rear images of the planter M shot by the camera S11 for remote travelling of the planter M, as shown in FIG. 5.

At this point, according to an operator's request, the images may be changed into a navigational mode providing easy and convenient remote travelling. That is, the calculating module S30 performs compositing of the front and rear images of the planter M shot by the camera S11 into a single image, and overlays the front and rear composite image with a real picture or an object modeled in three dimensions of the planter M.

The calculating module S30 reflects sensing information of the incline sensor S14 on the overlaid planter M so as to code a real travelling state into an augmented or virtual reality image. It is also possible that a side image is included in the composite image when the camera S11 is attached to each of the opposite sides of the planter M, which is described above.

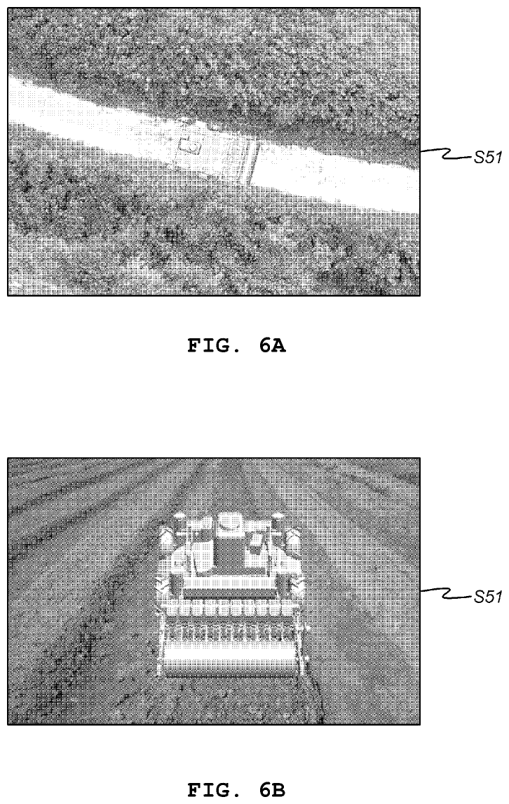

At this point, according to an operator's choice, the calculating module S30 codes the composite image into an aerial view and a bird's-eye view. As shown in FIG. 6A, the aerial view is taken from a vertically top-down point of view and shows the planter M in line with a travelling direction thereof. As shown in FIG. 6B, the bird's-eye view is taken from a bird's point of view and shows the planter M in line with the travelling direction thereof and geographic features.

The bird's-eye view requires perspective and the images captured by the camera have perspective, thus the images may be composed into the single image on the basis of an image capturing a shooting direction without a separate process. However, in order to provide the aerial view, a process of removing perspective by converting the images shot by the camera into a reverse projection is required.

The aerial view and the bird's-eye view may be output simultaneously the display module S50 according to an operator's request. It is also possible that the aerial view and the bird's-eye view shows the way on the location-basis by the GPS S12 in conjunction with a map application.

The safety module S40 performs analysis of a travelling state by comparing the sensing information to reference information set by the operator as shown in FIGS. 1 and 2, and outputs warning sound and warning light depending on the travelling state. That is, when the input sensing information is insufficient or exceeds the reference information, the safety module S40 determines the information as an error and outputs the warning sound and warning light so that the operator can immediately perceive. It is also possible that the safety module S40 stops the travelling of the planter M when the information is determined as the error.

For example, when the planter M is not travelled in a precise direction or obstacles are on a travelling direction, the safety module S40 outputs the warning sound and warning light which are perceivable by the operator. In addition, when it is determined that the planter M does not perform seed dropping and seed planting precisely by analyzing images of planting area shot by the camera S11, the safety module S40 outputs the warning sound and warning light.

When there is no signal from the operator even though the warning sound and warning light are output, the safety module S40 may automatically avoid obstacles or stop travelling of the planter M. In addition, the safety module S40 records position information of the GPS S12 with a picture for a poor planting area to induce rapid solution.

As described above, as the monitoring system notifies the operator with visible and audible alarms for the poor planting and remotely transmits and outputs a variety of information and information recording the total amount of planting seeds and amount of applied fertilizer, production management can be easily performed due to planting history and completeness of overall planting work can be maximized.

The display module S50 is attached to the controller C and shows the sensing information as an image, as shown in FIGS. 1 and 2. That is, the display module S50 is a touchable monitor, and basically, outputs an image divided into an observation item S51 and a measurement item S55. That is, the observation item S51 shows the shot images of the camera S11 attached to the planter M and the measurement item S55 shows a travelling state of the planter M.

At this point, the observation item S51 is provided on a left side in display module S50 and organized into a front field S51a showing the front image of the planter M, and a rear field S51b showing the rear image thereof at a lower end of the front field S51a, as shown in FIG. 5. It is also possible that the front field S51a and the rear field S51b are realized as the aerial view and the bird's-eye view described above, as shown in FIGS. 6A and 6B.

On a right side of the observation item S51, the measurement item S55 is organized into a connection field S55a, a voltage field S55b, a fuel field S55c, a posture field S55d, a direction field S55e, and a moving field S55f in a vertically listing manner.

That is, the connection field S55a shows a frequency sensitivity state into a bar graph shape, the voltage field S55b shows a battery power status of the planter M into a unit digit, the fuel field S55c shows fuel amount or an operable time of the planter M into an unit or a percentage, the posture field S55d shows an angle of the planter M into a unit number or the unit digit or an object shape, and the moving field S55f shows a moving distance or area of the planter M into the unit digit.

Accordingly, the operator can perform precise and stable control through the display module S50 attached to the wireless controller C at a sealed room like controlling at a planting field, a beginner can easily control by applying the image analysis, and automatic travelling is also possible depending on the setting.

Hereinbelow, a process of operating the planter M by the monitoring system of the present invention will be described.

First, the operator turns the power of the wireless controller C and the power of the planter M on. At this point, the planter M is maintained in a hot standby state and then may be turned automatically on and off along with the power of the wireless controller C.

When the power of the wireless controller C and the power of the planter M are turned on, the communication module S20 checks the connection state therebetween to display it on the safety module S40 and the display module S50. That is, when the connection state is normal, a good communication lamp is turned on, and when the connection state is poor, a bad communication lamp is turned on.

In addition, through a signal from the detecting module S10, positions of a battery of the wireless controller C, a battery of the planter M, and an engine throttle of the planter M are output and self-checked. When the positions are not checked and are not in a correct state, an error lamp is turned on.

Subsequently, the operator runs an engine of the planter M with the wireless controller C. When running failure is checked by the detecting module S10, re-running is repeated by a set number of times. When the running succeeds, depending on a set-up sequence, a signal required for the travelling or the planting work is required and input to the monitoring system.

For example, when the operator starts the planting work, the operator sets the above-described planting information and then starts the planting work. At this point, the operator checks a planting area via the display module S50 to observe the travelling and planting state with the naked eye. When necessary, the automatic travelling (planting) is also possible after the planting setting.

Meanwhile, the planter M in which the monitoring system of the present invention is applied will be described as follows.

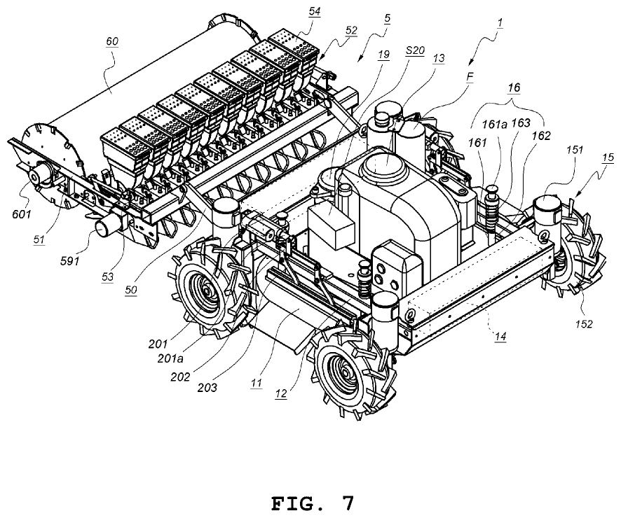

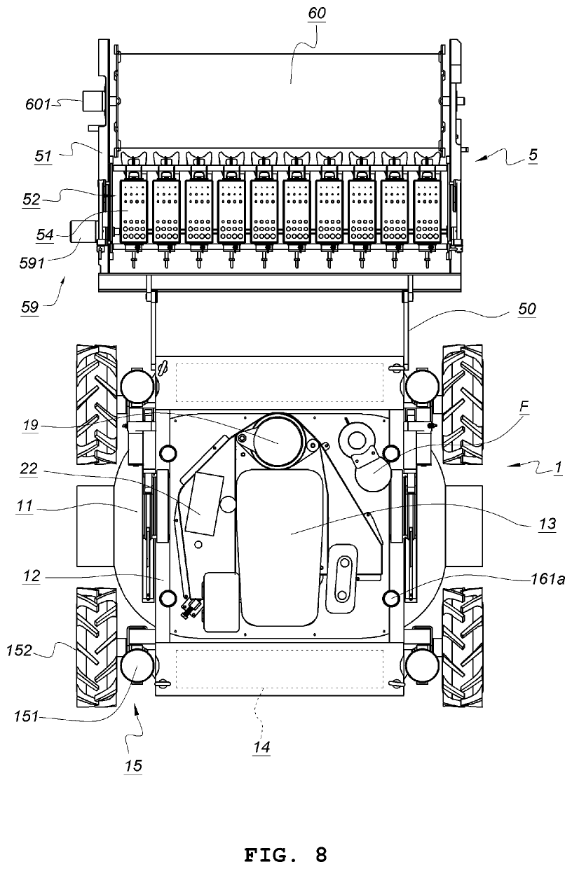

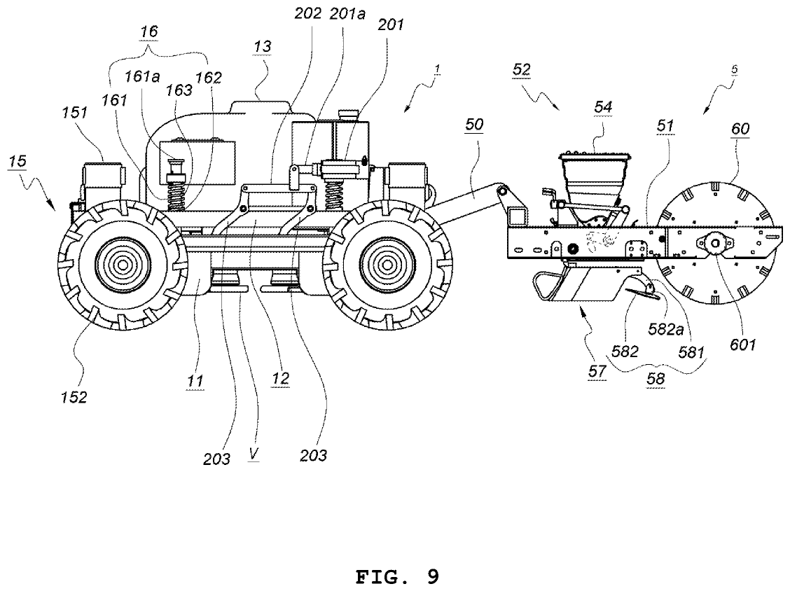

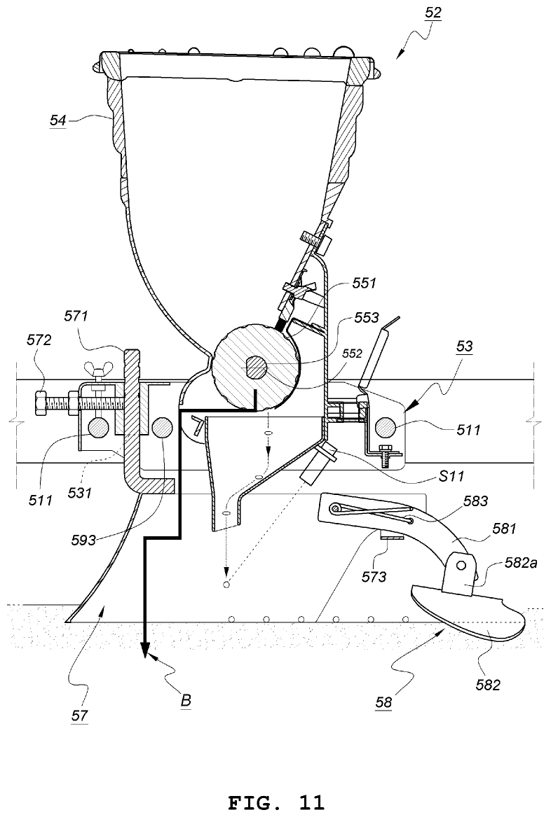

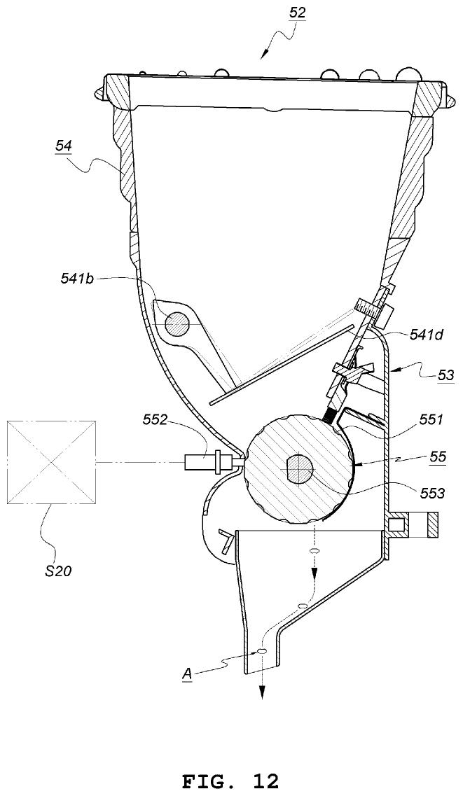

The planter M of the present invention includes: the RC bogie 1 remotely controlled by the wireless controller C; and the planting unit 5 performing the planting work by being installed in the RC bogie 1, as shown in FIGS. 7 to 15.

First, the RC bogie 1 includes: a main frame 11; a sub frame 12; an engine 13; a generator 19; a battery 14; a driving part 15; a damper part 16; an electric cylinder 201; and a blade V, as shown in FIGS. 7 to 10.

The main frame 11 is formed in a plate shape and provided at the center of the RC bogie 1. The sub frame 12 is formed in a rectangular frame and provided on an upper portion of the main frame 11 with a predetermined distance. The engine 13 is a gasoline or diesel type engine and provided on the upper portion of the main frame 11. At this point, a fuel tank F is provided on the upper portion of the main frame 11 to supply fuel to the engine 13.

The generator 19 is provided on the upper portion of the main frame 11 and generates electricity by being connected to the engine 13 so as to receive a rotational force of the engine 13. The battery 14 is provided on the sub frame 12 and charged by the generator 19 that is received the power of the engine 13.

The driving part 15 is provided in multiple, and the driving parts 15 are respectively disposed front and rear at opposite sides of the sub frame 12, and drive wheels 152 by power of the battery 14 to generate a driving force. The driving part 15 is provided with a wheel motor 151 that is operated by power supplied from the battery 14 to enable reversible rotation and control the number of rotation, and each of the wheels 152 is coupled to a driving shaft provided in the wheel motor 151 and rotated by power supplied from the wheel motor 151. That is, rotation of the wheel 152 of each of the driving parts 15 disposed front and rear at the opposite sides of the sub frame 12 is controlled independently so that a variety of travelling directions of the RC bogie 1 such as forward movement, rearward movement, and turning movement is possible.

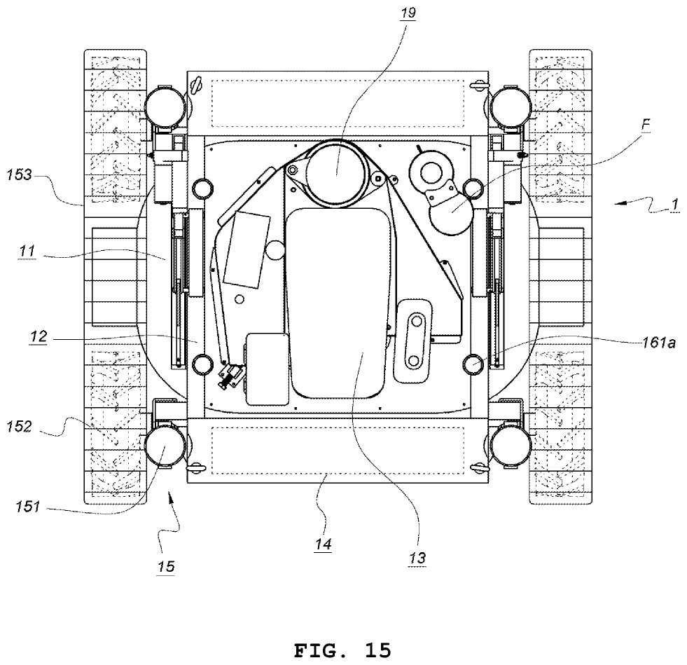

At this point, the driving part 15 may be further provided with a caterpillar 153, as shown in FIG. 15. The caterpillar 153 connects the wheels 152 provided front and rear at each of the opposite sides of the sub frame 12. The caterpillar 153 connecting the wheels 152 provided front and rear at each of the opposite sides of the sub frame 12 transmits the driving force of the wheels 152 to the ground when the wheels 152 are moved, so that it is possible to prevent the print of the wheels 152 generated when the ground caves in by the wheels 152 while the travelling of the RC bogie 1 is performed. Furthermore, the planting work is possible even with a small turning radius and efficient travelling is possible even at an inclined place.

The damper part 16 is provided between the main frame 11 and the sub frame 12 to relieve shock. The damper part 16 includes a damping rod 161, a guide bush 162, and a spring 163 for relieving shock between a main frame 11 and the sub frame 12. The damping rod 161 is formed by protruding vertically upward from an upper surface of the main frame 11, the guide bush 162 is formed by protruding vertically from the sub frame 12 so that the damping rod 161 passes through the guide bush 162.

The spring 163 is provided between a locking step 161a that is formed at an upper end of the damping rod 161 and an upper end of the guide bush 162. Thus, a weight of the main frame 11 formed by being space apart from the sub frame 12 is supported by an elastic force of the spring 163 so that a lower surface of the main frame 11 is prevented from being in contact with the ground. In addition, vibration of the main frame 11 generated when the RC bogie 1 travels is relieved by the spring 163.

That is, when vibration of the sub frame 12 is transmitted to the main frame 11 as the RC bogie 1 travels on a rough road, the main frame 11 vibrates up and down. The up and down vibration of main frame 11 is absorbed and relieved by the elastic force of the spring 163, which is provided between the damping rod 161 disposed at the main frame 11 and the guide bush 162 disposed at the sub frame 12.

The electric cylinder 201 is interposed between the main frame 11 and the sub frame 12 and functions to lift and lower the main frame 11. The electric cylinder 201 is fixed to the sub frame 12 so that a rod 201a faces forward. In addition, a link assembly is mounted to the sub frame 12 so as to wobble with respect to the sub frame 12, the link assembly is configured such that an upper end 202 thereof is hinge-connected to the rod 201a and a lower end 203 thereof is hinge-connected to the main frame 11.

Thus, when the rod 201a is moved forward, the main frame 11 is moved rearward and lowered by wobbling of the link assembly. On the contrary, when the rod 201a is moved rearward, the main frame 11 is moved forward and lifted by reversed wobbling of the link assembly.

At this point, since the main frame 11 is lifted and lowered while being moved forward and rearward by the wobbling of the link assembly, the above configuration should be adjusted so as not to interfere with another configuration. In addition, the electric cylinder 201 is configured to receive power from the battery 14.

The blade V is exposed to a lower side of the main frame 11, and performs weeding work by being connected to the engine 13 to receive a rotational force from the engine 13. The blade V is mounted to a shaft (not shown) rotatably coupled to the engine 13. Here, the shaft is supported by the main frame 11 and protrudes toward the lower side of the main frame 11.

In order to prevent deformation such as bending or fracture due to direct connection between the engine 13 and the shaft, which are inclined with the main frame 11 on a sharp inclined place and to induce a correct power transmission, it is preferable that an universal joint or a V-BELT pulley is provided between the blade V and the engine 13 to induce safe work in various environments.

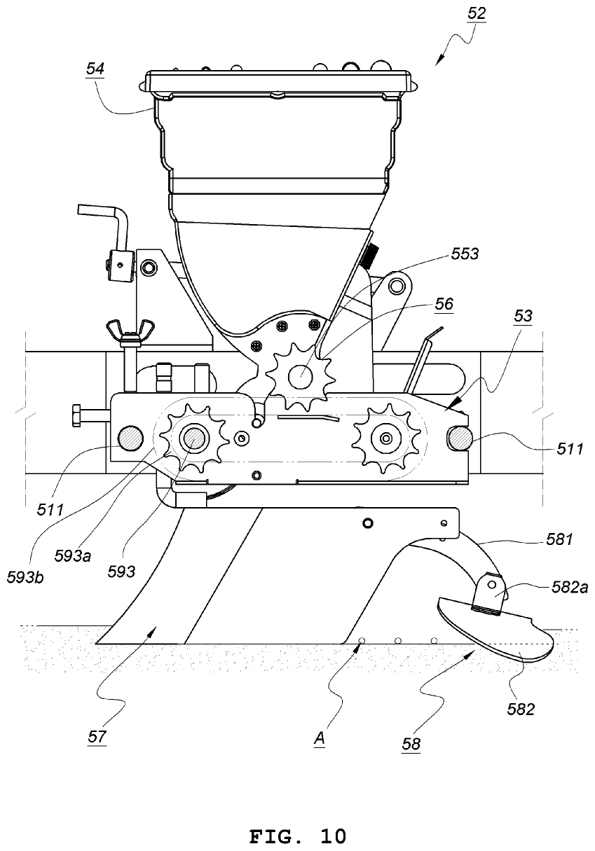

Subsequently, the planting unit 5 includes: a front frame 50, a side frame 51, a planting module 52, a driving means 59, and a compacting roller 60, as shown in FIGS. 10 to 14.

The front frame 50 is installed by being connected to a rear portion of the RC bogie 1 and side frames 51 are formed by protruding rearward from opposite sides of the front frame 50.

A plurality of planting modules 52 is provided on a connection bar 511 that is formed between the side frames 51 at a regular interval. The planting module 52 includes the mounting unit 53, a hopper 54, the planting roller 55, a roller sprocket 56, a plow 57, and a covering soil compaction means 58 for performing the planting.

At least a plurality of connection bars 511 provided between the opposite side frames 51 pass through the mounting unit 53 to support the mounting unit 53. The hopper 54 is provided at an upper portion of the mounting unit 53 to store seeds for planting.

At this point, the hopper 54 is made of transparent synthetic resin material with excellent weather resistance to check remaining amount of the seeds for planting stored therein and to prevent oxidation by natural light or ultraviolet rays, and is detachably coupled to the mounting unit 53.

The planting roller 55 is rotatably provided inside the hopper 54, and seed discharging grooves 551 are formed at an outer circumferential surface of the planting roller 55 in a radial shape. As the planting roller 55 is rotated, seeds introduced into the seed discharging grooves 551 are discharged out of the hopper 54.

At this point, a size and a shape of each of the seed discharging grooves 551 may be changed depending on type of seeds for planting, and are formed in various shapes such as hemispherical, elliptical, and granular in response to a size and a shape of a seed planted at one. For example, when a seed is spherical, the seed discharging groove 551 is formed in a hemispherical shape in response to a size and a shape of the seed so that a single spherical seed may be introduced therein.

The planting roller 55 is preferably made of electro conductive synthetic resin so as to discharge static electricity generated by friction through a rotational shaft 553. As the planting roller 55 made of electrically conductive synthetic resin and provided inside the hopper 54 rotates, static electricity is generated in the planting roller 55 by frictional charging due to friction between the outer circumferential surface of the planting roller 55 and the seeds stored in the hopper 54.

That is, the planting roller 55 is made of the electro conductive synthetic resin, so the planting roller 55 has low electrical resistance and excellent conductivity. Therefore, static electricity generated by the planting roller 55 flows into the mounting unit 53 through the metal rotational shaft 553, which is coupled to the center of the planting roller 55, and then is discharged to the ground through the metal plow 57, which is provided in a lower portion of the mounting unit 53.

That is, the seeds inside the hopper 54 are prevented from being attached to the outer circumferential surface of the planting roller or the seed discharging grooves 551 provided on the outer circumferential surface of the planting roller 55 due to static electricity. Accordingly, the seeds introduced into the seed discharging grooves 551 during the rotation of the planting roller 55 are dropped naturally and smoothly, so that it is possible to maintain an interval of plants and an interval of rows precisely by preventing poor planting caused by static electricity.

The roller sprocket 56 is provided at an outside end of the rotational shaft 553 of the planting roller 55 and transmits power that is received from the driving means 59 to the rotational shaft 553, so that the planting roller 55 is rotated and the seeds are discharged.

The plow 57 is provided at a lower portion of the mounting unit to be lifted and lowered to form a planting groove with a predetermined depth on an upper surface of a ridge. Thereby, the seeds discharged by the planting roller 55 are dropped into the planting groove, thus the planting is performed.

The plow 57 forms the planting groove on the upper surface of the ridge along a moving direction of the planter. In addition, the plow 57 is made of a metal material for discharging static electricity discharged from the planting roller 55 to the ground and is coupled to the lower portion of the mounting unit 53 in an upward and downward movable manner.

That is, a coupling rod 571 is formed by protruding upward from the plow 57 and is inserted into a coupling hole 531 at another side of the mounting unit 53 from the bottom to the top, and from the front of the mounting unit 53. In addition, a fixation bolt 572 is screw-coupled to the coupling rod 571 perpendicular to the coupling hole 531 to fix an outer circumferential surface of the coupling rod 571 with pressure. Therefore, as the fixation bolt 572 is tightened and loosened, a height of the plow 57 may be adjusted.

Accordingly, when it necessary to form a planting groove, the planting groove is formed on the upper surface of the ridge along the moving direction of the planter as the plow 57 is fixed while being adjusted the height thereof for insertion of a proper depth into the surface of the ridge. At the same time, the plow 57 being in contact with the ground allows static electricity discharged from the planting roller 55 and flowing through a power transmission shaft 593 and the mounting unit 53 of a metal material to be finally discharged to the ground, whereby discharging of static electricity caused from the planting roller 55 is smoothly performed.

On the other hand, when formation of the planting groove is unnecessary, the height of the plow 57 is fixed as high as possible to prevent contact between the plow 57 and the ground, thus facilitating movement of the planter M.

The covering soil compaction means 58 is elastically provided in the rear of the plow 57 and covers the seeds, which are discharged from the planting roller 55 and dropped into the planting groove, with soil to complete the planting. The covering soil compaction means 58 includes: a connection plate 581; a soil covering plate 582; and a torsion spring 583.

The connection plate 581 is coupled to one side of the plow 57 so as to wobble such that a first end thereof is hinge-coupled thereto. The soil covering plate 582 is formed in a downward bent shape so that opposite side ends thereof are in contact with the ground. On an upper portion of the soil covering plate 582, a coupling plate 582a is formed by protruding and is coupled to a second end of the connection plate 581 so as to be angle-adjustable by bolt-nut fastening.

The torsion spring 583 is provided by being inserted with a hinge pin, such that a first end thereof is fixed to the plow 57 and a second end thereof is fixed to the connection plate 581 to elastically close contact the soil covering plate 582 with the ground. That is, when the planting groove is formed on the upper surface of the ridge by the plow 57 as the planter M travels, the soil covering plate 582, which is provided on the second end of the wobbling connection plate 581, is elastically in close contact with the upper surface of the ridge as an elastic force of the torsion spring 583 is applied, and by process of the planter, the soil covering plate 582 scrapes soil on opposite sides of the planting groove to the center to cover the planting groove. As a result, as the seeds dropped into the planting groove are covered with the soil, the planting is completed.

At this point, when the connection plate 581 wobbles elastically by the elastic force of the torsion spring 583, in order to prevent excessive wobbling of the connection plate 581, it is preferable that a pedestal 573 is provided at the one side of the plow 57 where the connection plate 581 is coupled by hinge fastening for supporting the connection plate 581.

The driving means 59 is provided at the side frame 51 and includes: a driving motor 591, a driving sprocket 592, a power transmission shaft 593, a driven sprocket 594, and a roller chain 595 for driving the planting module 52.

The driving motor 591 is provided at one side of the side frame 51 and is driven in conjunction with the number of rotations of the compacting roller 60 which is provided from an encoder 601 in the compacting roller 60. The driving sprocket 592 is provided at a driving shaft of the driving motor 591, and the power transmission shaft 593 is provided to penetrate the mounting unit 53 that is provided in the plurality of planting modules 52 disposed between the opposite side frames 51 at the same time.

At this point, the power transmission shaft 593 has a plurality of chain sprockets 593a disposed at regular intervals, and each of the chain sprockets 593a has a roller chain 593b to transmit power to the roller sprocket 56 provided at the rotational shaft 553 of the planting roller 55 of the planting module 52. Accordingly, by rotation of the power transmission shaft 593, the planting rollers 55 of all the planting modules 52 are rotated at the same speed at the same time. In addition, the driven sprocket 594 is provided at one end of the power transmission shaft 593.

The roller chain 595 is provided to connect the driving sprocket 592 and the driven sprocket 594. Thus, the power transmission shaft 593 is rotated by the driving motor 591 that is driven in conjunction with the number of rotations of the compacting roller 60, and the planting rollers 55 of all the planting modules 52 are rotated at the same speed at the same time.

The compacting roller 60 is provided in a rear portion of the side frame 51 so as to be rotatable by friction with the ground. As the planting unit is progressed, after the seeds are planted by the planting module 52, the ridge in which the seeds are covered with soil is compacted by the compacting roller 60 under pressure due to a compacting roller's weight. On one side of the compacting roller 60, the encoder 601 is provided to detect the number of rotations of the compacting roller 60 and send the result to a controller of the driving motor 591. At this point, preferably, the compacting roller 60 has a spike in the radial shape on an outer circumferential surface thereof so that the compacting roller 60 is precisely rotated without slipping when the compacting roller 60 is rotated due to friction with the ground.

Meanwhile, the planting roller 55 further has an electro-static discharge detecting means 552 on one side thereof, the electro-static discharge detecting means 552 detecting whether static electricity generated from the planting roller 55 is discharged or not, and outputs the detected signal to the communication module S20. As described above, on the one side of the mounting unit 53, the camera S11 is mounted to capture an image of a state of seeds which are discharged from the planting roller 55 and planted into the planting groove on the ground.

In addition, the hopper 54 may further have a vibration means 541 on one side thereof to generate vibration. For example, as shown in FIG. 13, the vibration means 541 is provided with a vibration motor 541a at one side of the rotational shaft 553 of the planting roller 55 to allow the planting roller 55 to vibrate. That is, when the planting roller 55 vibrates by the vibration motor 541a, the seeds for planting can be precisely inserted into the seed discharging grooves 551 when the seeds for planting, which are stored in the hopper 54, are inserted into the seed discharging grooves 551 formed in the radial shape on the outer circumferential surface of the planting roller 55.

At this point, each of the seed discharging groove 551 on the outer circumferential surface of the planting roller 55 is formed in a shape corresponding to a size and a shape of a seed to be planted. Therefore, when the planting roller 55 is rotated at a lower portion of the hopper 54 where the seeds for planting are stored, among the seeds inside the hopper 54, one of seeds adjacent to the planting roller 55 is inserted into the seed discharging groove 551.

However, when a seed has a long ellipse shape, the seed cannot be precisely inserted into the seed discharging groove 551 of the planting roller 55, and is transferred by rotation of the planting roller 55 in a state of draping a part thereof on the seed discharging groove 551, and finally, the seed is returned to the inside of the hopper 54 from the seed discharging groove 551 so that the planting cannot be performed.

Accordingly, when the planting roller 55 vibrates by the vibration means 541 while a seed is not precisely inserted into the seed discharging groove 551, but is partially caught on the seed discharging groove 551, the seed partially caught on the seed discharging groove 551 is precisely inserted into the seed discharging grooves 551 or completely escapes therefrom and another seed adjacent thereto is inserted again into the seed discharging groove 551. Thus, seed discharging from the hopper 54 by the planting roller 55 is performed more precisely.

At this point, as the vibration motor 541a is provided at the one side of the hopper 54 to generate vibration of the hopper 54, it is possible to improve accuracy of seed inserting and discharging by the planting roller 55 provided at the lower portion of the hopper 54.

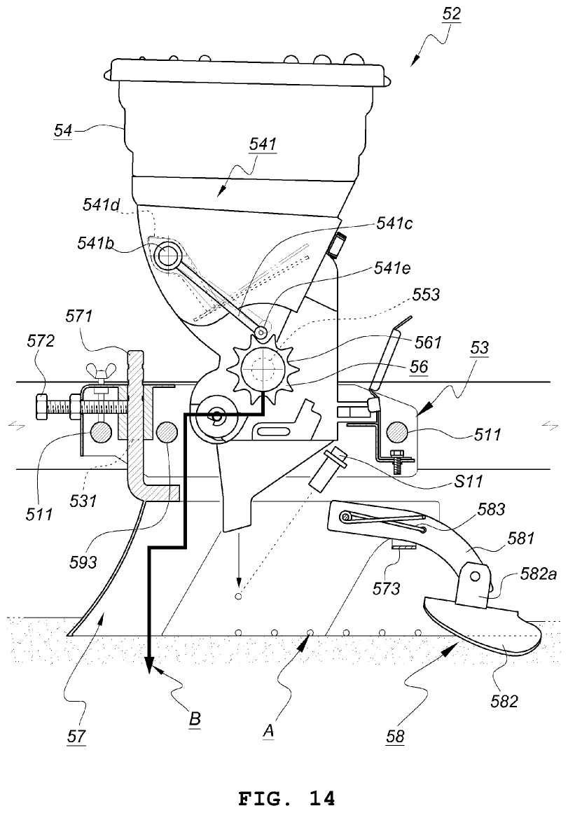

In another example, the vibration means 541 may include: a wobbling shaft 541b; an operation rod 541c; and a vibration plate 541d; as shown in FIG. 14. The wobbling shaft 541b is configured such that opposite ends thereof are rotatably provided at opposite side walls of the hopper 54 so as to be in the hopper 54.

The operation rod 541c is configured such that a first end thereof is fixed to an outside end of the wobbling shaft 541b and a second end thereof wobbles up and down due to rotation of the planting roller 55 by providing a contact roller 541e that is inserted inside a tooth groove 561 of the roller sprocket 56 provided at the outside end of the rotational shaft 553 of the planting roller 55.

The vibration plate 541d is provided inside the hopper 54, and one end thereof is fixed to the wobbling shaft 541b to shake seeds stored in the hopper 54 up and down while securing a regular space therein by a predetermined angular reversible rotation of the wobbling shaft 541b by the operation rod 541c.

Accordingly, when the roller sprocket 56 is rotated by the driving means 59, as the contact roller 541e provided at a first end of the operation rod 541c is lifted and lowered by an external diameter of the roller sprocket 56 in the tooth groove 561 of the roller sprocket 56, the wobbling shaft 541b where a second end of the operation rod 541c is coupled repeatedly performs reversible rotation with a predetermined angle.

At this point, the wobbling shaft 541b is provided inside the hopper 54 and the one side end of the vibration plate 541d provided inside the hopper 54 is fixed to one side of the outer circumferential surface of the wobbling shaft 541b. Thus, when the wobbling shaft 541b performs reversible rotation at the predetermined angle, the vibration plate 541d is reversibly rotated at a predetermined angle along with the wobbling shaft 541b, thereby shaking the seeds stored a predetermined space formed by a double partition in the hopper 54, so that the seeds are prevented from being agglomerated together inside the hopper 54 and correct planting is performed by inserting and discharging seeds into/from the seed discharging grooves. Accordingly, the vibration means 541 prevents blockage inside the hopper 54 due to the seeds, and allows the seeds inside the hopper 54 to be supplied quantitatively.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A monitoring system for controlling a wirelessly controlled planter (M), which is remotely controlled in conjunction with a wireless controller (C) that is configured with at least a plurality of buttons and joysticks, the monitoring system comprising:
a detecting module (S10) including a camera (S11) and a GPS (S12), at least one camera (S11) being attached to the planter (M) to capture an image of a surrounding and a planting area and the GPS (S12) measuring a location of the planter (M) and a moving distance thereof in real time;
a communication module (S20) provided in each of the controller (C) and the planter (M), sending and receiving a detected signal of the detecting module (S10) and a travelling signal of the planter (M);
a calculating module (S30) coding the detected signal sent to the controller (C) into readable sensing information and decoding manipulating information of an operator into the travelling signal that is perceived by the planter (M);
a safety module (S40) analyzing travelling state by comparing the sensing information to reference information set by the operator, and outputting a warning sound and a warning light depending on the travelling state; and
a display module (S50) attached to the controller (C) and outputting an observation item (S51) showing a surrounding of the planter (M) on the basis of the sensing information and a measurement item (S55) showing an operational state of the planter.

2. The monitoring system of claim 1, wherein the detecting module (S10) further comprises: an ultrasonic sensor (S13) provided in a front portion and a rear portion of the planter (M) to sense an obstacle; at least one incline sensor (S14) provided in the planter (M) to sense rolling, yawing, and pitching; and an OBD terminal (S15) connected to an electronic control unit (ECU) of the planter (M) to detect a battery state and amount of fuel.

3. The monitoring system of claim 1, wherein the communication module (S20) of the controller (C) is connected to a server of the Rural Development Administration of Korea via a private network to receive crop growth information such as a size of ridge, a head interval, a germination temperature, a cultivation temperature, a seasonal planting and harvesting time, a number of seeds, an interval of rows, and an interval of plants, according to an operator's request.

4. The monitoring system of claim 2, wherein the calculating module (S30) performs compositing of front and rear images of the planter (M) which are taken by the camera (S11), overlays a front and rear composite image with a real picture or an object modeled in three dimensions of the planter (M), and reflects sensing information of the incline sensor (S14) on the overlaid planter (M) so as to code a real travelling state into an augmented or virtual reality image.

5. The monitoring system of claim 4, wherein, according to an operator's choice, the calculating module (S30) codes the composite image into an aerial view and a bird's-eye view, the aerial view being taken from a vertically top-down point of view and showing the planter (M) in line with a travelling direction thereof, and a bird's-eye view being a view taken from a bird's point of view and showing the planter (M) in line with the travelling direction thereof and geographic features.

6. The monitoring system of claim 1, wherein the safety module (S40) performs analysis of an image of a planting area of the camera (S11) to determine seed dropping and seed planting and records position information of the GPS (S12) with a picture for an area of poor planting.

7. The monitoring system of claim 5, wherein the observation item (S51) of the display module (S50) is organized: on a left side in the display module, into a front field (S51a) showing a front image of the planter (M); and a rear field (S51b) showing a rear image of the planter (M) at a lower end of the front field (S51a); and
the measurement item (S55) is organized: on a right side of the display module, into a connection field (S55a) indicating a frequency sensitivity state; a voltage field (S55b) indicating a battery power state of the planter (M); a fuel field (S55c) indicating fuel amount or operable time of the planter (M); a posture field (S55d) indicating an angle of the planter (M); a direction field (S55e) indicating a travelling direction and speed of the planter (M); and a moving field (S55f) indicating a moving distance and an area of the planter (M), in a set pattern.
